(19) United States
(12) Patent Application Publication
(10) Pub. No.: US 2008/0069188 A1
(43) Pub. Date: Mar. 20, 2008

(54) Virtual reference timing for multi-time based systems

(76) Inventor: David R. Meyer, Lakewood, CO (US)

Correspondence Address: TENSORCOMM, INC., 1490 W. 121ST AVE., SUITE 202, WESTMINISTER, CO, 80234, US

(21) Appl. No.: 11/522,074

(22) Filed: Sep. 15, 2006

(51) Int. Cl. H04B 1/00; H04L 7/00

(52) U.S. Cl. 375/149; 375/354

(57) ABSTRACT

A timing-reference circuit is employed by a multi-time-based system in which a timing reference is required for system processing. The timing-reference circuit may be used in a wireless receiver in which one or more transmitted signals are received as multipath signals, each corresponding to a different time reference. The timing-reference circuit is configured for selecting at least one received signal in a set of multipath signals as a timing reference, tracking the timing reference with a virtual timing reference, and synchronizing receiver processing to the virtual timing reference, even when the actual timing reference from which the virtual reference was derived vanishes. The timing-reference circuit provides for re-acquisition of a new timing reference when the virtual reference no longer qualifies as a timing reference.

### BACKGROUND

1. Field of the invention

The present invention relates generally to a multi-time-based system in which a timing reference is used for system processing, and specifically to a wireless system configured to process received multipath signals, each having a different time reference.

2. Discussion of the Related Art

A multi-time-based system may process each of a plurality of received signals individually or in aggregate. In the aggregate case, a periodic timing reference is commonly used to sequence a processing-state machine. It is generally assumed that the entire sequence of the processing-state machine completes within the time frame of the periodic timing reference. A periodic timing reference is selected without regard to received signal timing. Prior-art systems commonly use a local oscillator that is not time-locked to any of the received signals. In some cases, a more complex process may employ a timing reference derived from one of the received signals using a prescribed timing-reference algorithm.

### SUMMARY OF THE INVENTION

In view of the foregoing background, embodiments of the present invention may provide for method and apparatus embodiments for deriving a timing reference from received signals, and maintaining timing-reference continuity in the event that the signal on which the timing reference is based no longer exists at a later time. Such embodiments provide for a virtual timing reference. Embodiments of the invention may be employed as an alternative to changing the system reference.

In one embodiment of the invention, a timing-reference system for a receiver configured to receive a multipath signal comprises a selection means, a tracking means, and a synchronization means. The selection means is configured for selecting at least one received signal in the multipath signal as a timing reference. The selection means may include, by way of example, but without limitation, a Rake receiver, a finger-selection algorithm, or any other apparatus or algorithm configured to select a periodic timing reference in a received signal.

The tracking means is configured to track the timing reference with a virtual timing reference. The tracking means may include, by way of example, but without limitation, a delay-locked loop tracker, a Tau-dither tracker, or any other component of a spread-spectrum receiver configured to track a received signal.

The synchronization means is configured to synchronize receiver processing to the virtual timing reference. The synchronization means may include any component or algorithm configured to align system processes with respect to a locally generated virtual timing reference.

Initially the virtual timing reference is based upon an existing signal in the manner prescribed by a timing-reference algorithm. The virtual timing reference will continue to track to the timing reference, including timing advances and retards, for as long as the underlying signal exists. In the case that the underlying signal no longer exists, the system processing will be timed to the virtual timing reference which is temporally equivalent to where the timing reference would have been had the original signal continued to exist without regard to any possible timing advances or retards.

The virtual timing reference will continue to provide system timing as long as the timing-reference algorithm indicates that the virtual timing reference is a satisfactory reference. When the timing-reference algorithm indicates that the virtual timing reference is an unsatisfactory reference, a new timing reference may be produced based upon currently received signals. The virtual timing reference will then track to the new timing reference.

In an alternative embodiment, the virtual timing reference may be allowed to advance or retard toward a timing-reference signal that continues to exist. The virtual timing reference may become the system timing reference when the timing-reference signal no longer exists, such as described previously. The timing-reference algorithm may compute a new candidate timing reference based upon received signals. The virtual timing reference advances or retards toward the candidate timing-reference signal. Once the virtual timing reference is locked to the candidate timing reference, the candidate timing reference becomes the timing reference. This assumes that the virtual timing reference continues to satisfy the timing-reference algorithm. If at any time, the virtual timing reference does not satisfy the timing-reference algorithm, then a new signal specified by the timing-reference algorithm must be used as the timing reference.

### BRIEF DESCRIPTION OF THE DRAWINGS

Embodiments according to the present invention are understood with reference to the schematic block diagram of FIG. 1, the flow diagram of FIG. 2, and the plots shown in FIGS. 3-5.

FIG. 1 illustrates a receiver comprising a timing-reference circuit 106 in accordance with one embodiment of the invention.

FIG. 2 illustrates a functional embodiment of the timing-reference circuit 106 shown in FIG. 1.

FIG. 3 depicts symbol boundaries of three received WCDMA/CDMA signals, a timing-reference signal, and a virtual timing reference signal.

FIG. 4 depicts symbol boundaries of received signals and a virtual timing reference signal after loss of the timing-reference signal in accordance with one embodiment of the invention.

FIG. 5 depicts symbol boundaries of received signals that require an adaptation of the virtual timing reference.

### DESCRIPTION OF PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

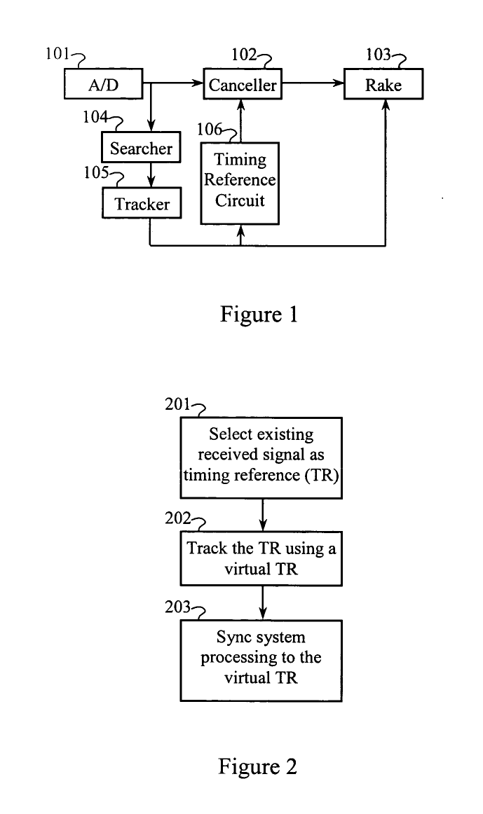

FIG. 1 illustrates a receiver comprising a timing-reference circuit 106 in accordance with one embodiment of the invention. Received signals are processed by an analog-to-digital converter (A/D) 101. Digitized signals from the A/D are processed by a searcher 104 and a tracker 105, which identify and track strong paths in a received multipath signal. The paths are processed by both the timing-reference circuit 106 and a Rake receiver. The timing-reference circuit 106 provides a timing-reference signal to an interference canceller 102 configured to cancel interference in the digitized received signal prior to Rake processing.

FIG. 2 illustrates a functional embodiment of the timing-reference circuit 106 shown in FIG. 1. A timing-reference algorithm processes the paths tracked by the searcher 104 and tracker 105 to identify 201 a timing reference. For example, the temporal distance between each successive symbol boundary is measured. The largest distance is then determined. The symbol boundary at the end of the largest distance is then denoted as the timing reference. The timing-reference algorithm may compute a new timing reference based upon changes in the channel conditions of the received signals.

A virtual timing reference is used to track 202 the timing reference. The virtual timing reference may comprise a clock that is initially locked to the timing reference. Since the timing reference may change or disappear as the channel changes, the virtual timing reference allows the system to function without requiring an immediate calculation of a new timing reference. Thus, system processing (e.g., the interference canceller 102) may be synchronized 203 to the virtual timing reference, even after the disappearance of the initial timing reference to which the virtual timing reference was locked.

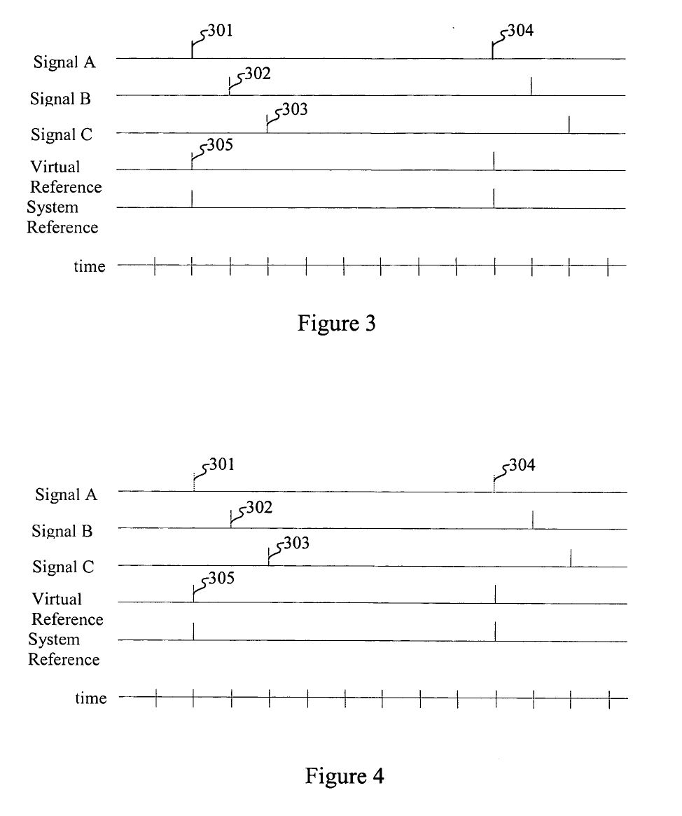

FIG. 3 depicts symbol boundaries of three received WCDMA/CDMA signals, a timing-reference signal, and a virtual timing reference signal. In one embodiment, the timing-reference algorithm determines that signal A should be the timing reference for the system. For example, the distance between signal A marker 301 and signal B marker 302 is one unit. The distance between signal B marker 302 and signal C marker 303 is one unit. The distance between signal C marker 303 and signal A marker 304 is six units. The interval between signal C marker 303 and signal A marker 304 is determined to be the longest. Since signal A is the temporally trailing signal of the signals separated by the longest interval, it is assigned as the reference signal. A virtual reference 305 tracks signal A to produce a virtual reference signal.

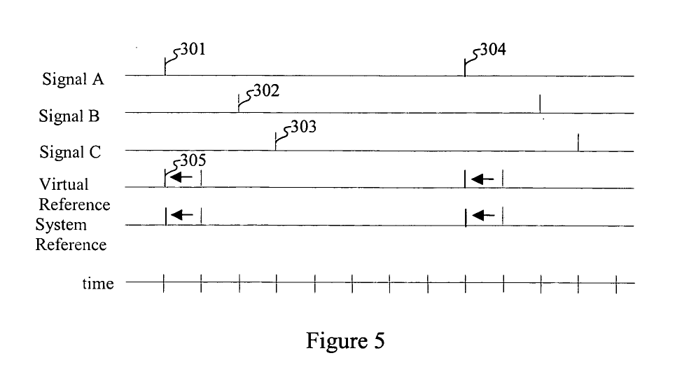

FIG. 4 depicts the loss of signal A, which was the timing-reference signal. The virtual reference is subsequently used as the reference. FIG. 5 depicts the addition of a new signal A that invalidates the use of the virtual reference. The marker for signal A is one unit before the virtual reference signal, signal B is still one unit after the virtual reference signal, and signal C is still one unit after signal B. In addition, signal A follows signal C by five units, which is the largest temporal difference. In this case, signal A should be declared as the reference signal. The virtual reference may now be adapted to track signal A.

It is clear that the methods described herein may be realized in hardware or software, and there are several modifications that can be made to the order of operations and structural flow of the processing. Those skilled in the art should recognize that method and apparatus embodiments described herein may be implemented in a variety of ways, including implementations in hardware, software, firmware, or various combinations thereof. Examples of such hardware may include Application Specific Integrated Circuits (ASICs), Field Programmable Gate Arrays (FPGAs), general-purpose processors, Digital Signal Processors (DSPs), and/or other circuitry. Software and/or firmware implementations of the invention may be implemented via any combination of programming languages, including Java, C, C++, Matlab™, Verilog, VHDL, and/or processor specific machine and assembly languages.

The functions of the various elements shown in the drawings may be provided through the use of dedicated hardware, as well as hardware capable of executing software in association with appropriate software. These functions may be performed by a single dedicated processor, by a shared processor, or by a plurality of individual processors, some of which may be shared. Moreover, explicit use of the term “processor” or “circuit” should not be construed to refer exclusively to hardware capable of executing software, and may implicitly include, without limitation, digital signal processor DSP hardware, read-only memory (ROM) for storing software, random access memory (RAM), and non-volatile storage. Other hardware, conventional and/or custom, may also be included. Similarly, the function of any component or device described herein may be carried out through the operation of program logic, through dedicated logic, through the interaction of program control and dedicated logic, or even manually, the particular technique being selectable by the implementer as more specifically understood from the context.

The method and system embodiments described herein merely illustrate particular embodiments of the invention. It should be appreciated that those skilled in the art will be able to devise various arrangements, which, although not explicitly described or shown herein, embody the principles of the invention and are included within its spirit and scope.

Furthermore, all examples and conditional language recited herein are intended to be only for pedagogical purposes to aid the reader in understanding the principles of the invention. This disclosure and its associated references are to be construed as applying without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A timing-reference circuit employed in a receiver configured for receiving multipath signals, the timing-reference circuit configured for selecting at least one received signal in the multipath signals as a timing reference, tracking the timing reference with a virtual timing reference, and synchronizing receiver processing to the virtual timing reference.

2. The timing reference circuit recited in claim 1, wherein the timing-reference circuit comprises a clock.

3. The timing reference circuit recited in claim 1, further configured for implementing a timing-reference algorithm that determines whether the virtual timing reference is a satisfactory reference.

4. The timing reference circuit recited in claim 3, wherein the timing-reference algorithm is further configured for selecting a new received signal as the timing reference and tracking the new timing reference with the virtual timing reference.

5. The timing reference circuit recited in claim 1, further configured to advance or retard the virtual timing reference toward the timing-reference signal.

6. A timing-reference method employed in a receiver configured for receiving a multipath signal, the method comprising:
providing for selecting at least one received signal in the multipath signal as a timing reference,
providing for tracking the timing reference with a virtual timing reference, and
providing for synchronizing receiver processing to the virtual timing reference.

7. The method recited in claim 6, wherein providing for tracking comprises locking a clock to the timing reference.

8. The method recited in claim 6, further comprising providing for implementing a timing-reference algorithm that determines whether the virtual timing reference is a satisfactory reference.

9. The method recited in claim 8, further comprising providing for selecting a new received signal as the timing reference and tracking the new timing reference with the virtual timing reference.

10. The method recited in claim 6, wherein providing for tracking further comprises advancing or retarding the virtual timing reference toward the timing-reference signal.

11. A timing-reference system for a receiver configured to receive a multipath signal, the timing-reference system comprising:
a selection means configured for selecting at least one received signal in the multipath signal as a timing reference,
a tracking means configured for tracking the timing reference with a virtual timing reference, and
a synchronization means configured for synchronizing receiver processing to the virtual timing reference.

12. The system recited in claim 11, wherein the tracking means is configured for locking a clock to the timing reference.

13. The system recited in claim 11, wherein the tracking means is further configured for implementing a timing-reference algorithm that determines whether the virtual timing reference is a satisfactory reference.

14. The system recited in claim 13, wherein the selection means is further configured for selecting a new received signal as the timing reference and tracking the new timing reference with the virtual timing reference.

15. The method recited in claim 11, wherein the tracking means is further configured for advancing or retarding the virtual timing reference toward the timing-reference signal.
